(19) United States
(12) Patent Application Publication
(10) Pub. No.: US 2010/0118319 A1
(43) Pub. Date: May 13, 2010

(54) IMAGE FORMING SYSTEM, IMAGE FORMING METHOD, AND COMPUTER READABLE MEDIUM

(75) Inventors: Naoki HIRAKO, Ebina-shi (JP); Keita Kumokiri, Ebina-shi (JP)

Correspondence Address: SUGHRUE-265550, 2100 PENNSYLVANIA AVE. NW, WASHINGTON, DC, 20037-3213, US

(73) Assignee: Fuji Xerox Co., Ltd., Tokyo (JP)

(21) Appl. No.: 12/429,729

(22) Filed: Apr. 24, 2009

(30) Foreign Application Priority Data
Nov. 7, 2008 (JP) 2008-286645

(51) Int. Cl. H04N 1/60

(52) U.S. Cl. 358/1.9

(57) ABSTRACT

An image forming system includes: an image forming apparatus; a first recording member; a second recording member storage; and a control unit that, when the image forming apparatus firstly forms an image on a first recording member and secondly forms an image on a second recording member, executes a first control in which the discharge of the second recording member from the second recording member storage is carried out before the discharge of the first recording member from the first recording member storage, and a second control in which the discharge of the second recording member from the second recording member storage is carried out after the discharge of the first recording member from the first recording member storage, the control unit selecting any one of the first and second controls according to the number of the first recording members stored in the first recording member storage.

### CROSS-REFERENCE TO RELATED APPLICATIONS

This application is based on and claims priority under 35 U.S.C. 119 from Japanese Patent Application No. 2008-286645 filed Nov. 7, 2008.

### BACKGROUND

### Technical Field

The present invention relates to an image forming system, an image forming method, and a computer readable medium.

### SUMMARY

According to an aspect of the present invention, an image forming system includes: an image forming apparatus that forms an image on a recording member; a first recording member storage that stores a first recording member therein; a second recording member storage that stores a second recording member therein, and that has a longer distance from the image forming apparatus than the distance of the first recording medium storage from the image forming apparatus; and a control unit that, when the image forming apparatus firstly forms an image on the first recording member and secondly forms an image on the second recording member, executes a first control in which the discharge of the second recording member from the second recording member storage is carried out before the discharge of the first recording member from the first recording member storage, and a second control in which the discharge of the second recording member from the second recording member storage is carried out after the discharge of the first recording member from the first recording member storage, the control unit selecting any one of the first and second controls according to the number of the first recording members stored in the first recording member storage.

### BRIEF DESCRIPTION OF THE DRAWINGS

Exemplary embodiment of the present invention will be described in detail based on the following figures, wherein:

FIG. 1 is a conceptual view of an example of an image forming system;

FIG. 2 is a block diagram of an example of a control system;

FIG. 3 is a conceptual view of an example of a control mode;

FIG. 4 is a conceptual view of an example of a control mode;

FIG. 5 is a conceptual view of an example of a control mode;

FIG. 6 is a conceptual view of an example of a control mode; and

FIG. 7 is a flow chart of an example of a control procedure.

### DETAILED DESCRIPTION

### (Structure of Image Forming System)

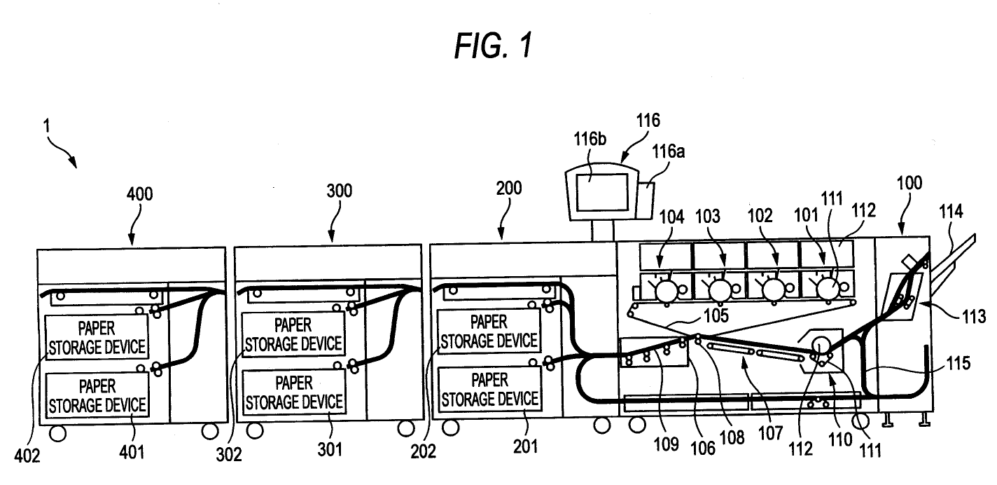

FIG. 1 is a conceptual view of an embodiment of an image forming system according to the invention. In FIG. 1, there is shown an image forming system 1. This image forming system 1 includes an image forming apparatus 100, a paper feed apparatus 200, a paper feed apparatus 300, and a paper feed apparatus 400 which are connected together. In this embodiment, there is illustrated an example which uses paper for printing (which is hereinafter referred to as paper) as a recording member. As the recording member, there can be used resin-made paper such as OHP paper or coated paper which is produced by coating a resin layer on the surface of paper.

### (Structure of Image Forming Apparatus)

Firstly, description will be given below of an image forming apparatus 100 according to the present embodiment. The image forming apparatus 100 has a function to form a color image on the paper. This image formation is carried out in such a manner that a color toner image obtained by attaching four color toners is heated and pressurized to thereby fix it onto the paper.

The image forming apparatus 100 includes primary transfer units 101 to 104. The four primary transfer units 101 to 104 are respectively structured such that they primarily transfer their respective a Y (yellow) toner image, an M (magenta) toner image, a C (cyan) toner image, and a K (black) toner image on a transfer belt 105. These respective transfer units are basically the same in structure with each other except for the toners to be used and, therefore, description will be given here only of the primary transfer unit 101.

The primary transfer unit 101 includes a sensitive drum 111 and adjoins an exposure device 112. The exposure device 112 scans and radiates a laser beam on the rotating sensitive drum 111 to sensitize the sensitive drum 111 in part, thereby forming an electrostatic latent image on the sensitive drum 111. Although not shown, in the periphery of the sensitive drum 111, there are disposed a cleaning member for removing the toner remaining on the sensitive drum 111, a charging device for charging the sensitive drum 111, and a developing device for supplying a toner to the sensitive drum 111 to develop the latent image.

The toner is attached to the sensitive drum 111 according to the latent image formed thereon, whereby a toner image is formed on the sensitive drum 111. This toner image is primarily transferred onto the transfer belt 10. Similar primary transfer operations are executed in the other primary transfer units 102 to 103 as well, while toner images of the respective basic colors YMCK are superimposed on top of each other on the transfer belt 105. In this manner, the color toner images are formed on the transfer belt 105.

The image forming apparatus 100 includes two paper feed mechanisms 106 and 107. The paper feed mechanism 106 feeds the paper taken in by the image forming apparatus 100 toward the position of a transfer roller 108. Here, reference numeral 109 designates a feed passage for the paper. Downstream of the paper feed mechanism 106, there is disposed the transfer roller 108. At the position of the transfer roller 108, the paper is held by and between the transfer roller 108 and transfer belt 105, while the toner image on the transfer belt 105 is secondarily transferred to the paper.

Downstream of the transfer roller 108, there is disposed the paper feed mechanism 107. The paper feed mechanism 107 feeds the paper with the toner image transferred thereto toward a fixing device 110. The fixing device 110 includes a heating belt 111 and a pressurizing roller 112. The heating belt 111 is heated by a heat roller (not shown) and is used to heat the paper held by and between the pressurizing roller 112 and itself. In this case, the thus held paper is heated and pressurized, while the toner image transferred onto the paper is fixed.

Downstream of the fixing device 110, there is disposed a post-processing device 113. The post-processing device 113 carries out processing such as a processing to arrange sheets of paper to be discharged to the outside, or a paper reversing processing when the images are formed on both sides of the paper. Downstream of the post-processing device 113, there is disposed a paper discharge surface 114 where the discharged sheets of paper accumulate. Here, reference numeral 115 designates a feed passage which is used when the images are formed on both sides of the paper.

The image forming system 1 shown in FIG. 1 includes an operation terminal 116. The operation terminal 116 functions as a terminal to operate the image forming system 1. The operation terminal 116 includes an operation portion 116a containing a keyboard for operation and a display 116b for displaying visually operation contents and various kinds of information thereon.

### (Structure of Paper Feed Apparatus)

In FIG. 1, there are shown the paper feed apparatuses 200, 300 and 400. These paper feed apparatuses 200 to 400 respectively include two paper storage devices and supply paper to the image forming apparatus 100. When the paper feed apparatus 300 supplies the paper to the image forming apparatus 100, firstly, it discharges the paper toward the paper feed apparatus 200. And, the paper discharged from the paper feed apparatus 300 is received by the paper feed apparatus 200 and then the paper feed apparatus 200 further discharges the paper toward the image forming apparatus 100 (that is, feeds the paper). Similarly, the paper discharged from the paper feed apparatus 400 is supplied through the paper feed apparatuses 300 and 200 to the image forming apparatus 100.

The paper feed apparatuses 200, 300 and 400 are basically the same in structure with each other. Description will be given below of the general structure of the paper feed apparatus 400 as the representative thereof. The paper feed apparatus 400 includes two paper storage devices 401 and 402. The paper storage devices 401 and 402 are structured such that they can correspond to multiple paper standards and can store therein paper selected from the multiple paper standards. The paper storage devices 401 and 402 respectively include a paper residual quantity detect means for detecting the residual quantity of paper (the number of sheets of paper remaining in the devices) to be stored therein. This paper residual quantity detect means is structured such that, using a photoelectric sensor, when the paper residual quantity provides 50 sheets of paper, it outputs a signal to notify such effect. This photoelectric sensor includes an LED and a light receiving sensor. In operation, the sensor detects the change of an optical axis for connecting together the LED and light receiving sensor from a state where the optical axis is shielded by the paper to a state where it is not shielded, and thereby outputs a signal to detect the residual sheets of paper. The above-mentioned paper residual quantity detect means also includes a mechanism which, making use of the same principle, detects whether the paper is absent or not (remaining number of paper=0 or not).

The other remaining paper feed apparatuses are also similar in structure. That is, the paper feed apparatus 200 includes two paper storage devices 201 and 202, while these paper storage devices include the above-mentioned paper residual quantity detect means respectively. Also, the paper feed apparatus 300 includes two paper storage devices 301 and 302, while these paper storage devices include the above-mentioned paper residual quantity detect means respectively.

Here, the means for detecting the remaining sheets of paper stored in the paper storage device may also have a structure which can detect the height of the remaining sheets of paper using a contact sensor, or a structure which can detect the weight of the bundle of sheets of paper using a pressure sensor.

Here, there is illustrated an example in which the three paper feed apparatuses are connected together. However, the number of the paper feed apparatuses to be connected may also be two or four or more. That is, the number of paper feed apparatuses to be connected can be selected according to image forming modes.

### (Structure of Control System)

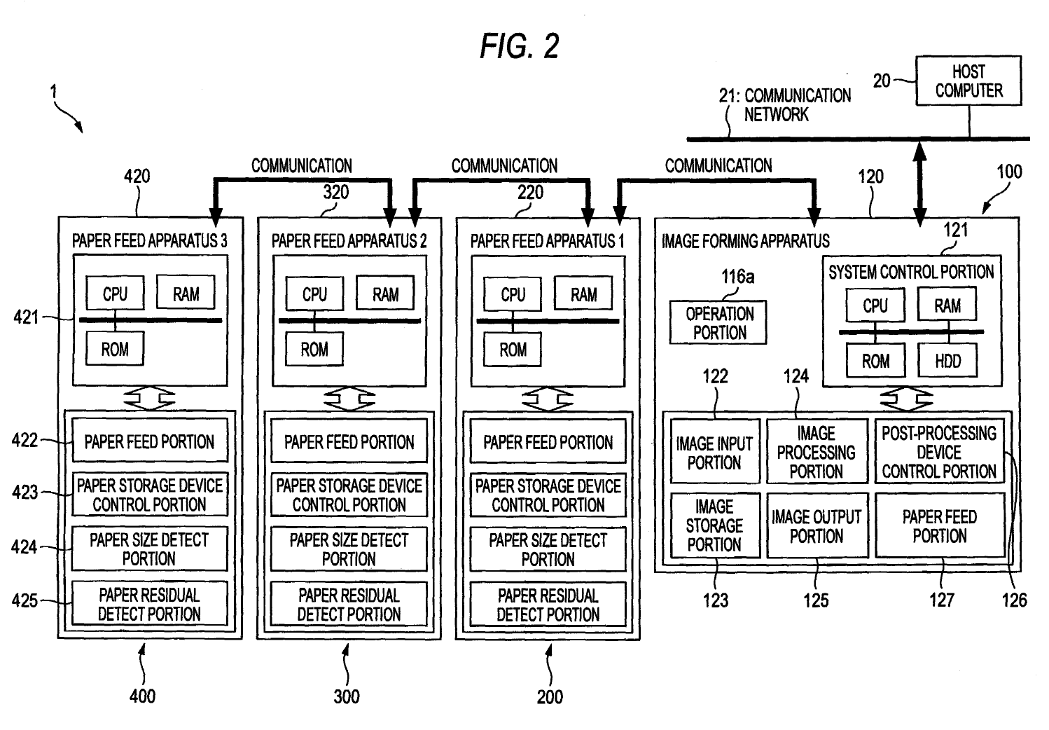

FIG. 2 is a block diagram of the structure of a control system employed in the present embodiment. Specifically, in FIG. 2, there are shown the control system 120 of the image forming apparatus 100 (see FIG. 1), the control system 220 of the paper feed apparatus 200, the control system 320 of the paper feed apparatus 300, and the control system 420 of the paper feed apparatus 400. Here, the control systems of the respective paper feed apparatuses are the same in structure.

Firstly, description will be given below of the control system 120 of the image forming apparatus 100. The control system 120 of the image forming apparatus 100 includes a system control portion 121 which is used to control the whole of the system shown in FIG. 1. The system control portion 121 has the function of a computer and also includes a CPU, a RAM, a ROM and an HDD. The CPU controls the general operation of the whole of the image forming system 1 shown in FIG. 1 and also carries out various calculations necessary for the respective operation control operations. The RAM is used to store programs and data necessary for processing, and also functions as a buffer memory or the working area of the CPU. The ROM stores therein programs and data necessary for processing. The HDD stores therein programs and data necessary for processing.

As shown in FIG. 2, the image forming apparatus 100 includes the operation portion 116a which is shown in FIG. 1 as well. Various settings in the systems shown in FIGS. 1 and 2 are to be carried out by an operator while operating this operation portion 116a.

The control system 120 is connected to the control system 220 of the paper feed apparatus 200 through communication means (a communication cable or communication means using electromagnetic waves), the control systems 220 and 320 are also connected together through communication means, and the control systems 320 and 420 are also connected together through communication means. Such communication means allows the control system 120 to communicate with the control systems 220 to 420.

Since the control systems 220, 320 and 420 are the same in structure with each other, description will be given below of the control system 420. The control system 420 includes a control portion 421. And, the control portion 421 includes a CPU, a RAM and a ROM. The CPU, which is the subordinate control unit of the system control portion 121, supervises the control of the operation of the paper feed apparatus 400. The RAM is used to store therein programs and data necessary for processing and also functions as a buffer memory or the working area of the CPU. The ROM stores therein programs and data necessary for processing. For example, information about the sizes of the paper to be stored in the paper storage devices 401 and 402 shown in FIG. 1 is stored in the RAM of the control portion 421.

The control system 420 includes a paper feed portion 422, a paper storage device control portion 423, a paper size detect portion 424 and a paper residual detect portion 425. The paper feed portion 422 controls a feed mechanism which carries out an operation to feed paper within the paper feed apparatus 400. For example, the control of the operation to discharge paper from the paper feed apparatus 400 to the paper feed apparatus 300 is carried out by the paper feed portion 422. The paper storage device control portion 423 controls the state of storage of paper in the paper storage devices 401 and 402. The paper size detect portion 424 detects the size of the paper to be stored into the paper storage devices 401 and/or 402. The paper residual detect portion 425 is a circuit portion which detects the number of the remaining sheets of the paper in the paper storage devices 401 and/or 402 using the above-mentioned photoelectric sensor (in the present embodiment, it detects whether the number of the remaining sheets of paper becomes 50 or not). Also, the paper residual detect portion 425 further has a function to detect whether paper is not left any longer in the paper storage devices 401 and/or 402 or not (whether the paper runs out or not).

The control portion 421 receives signals which are output from the paper size detect portion 424 and paper residual detect portion 425 and, according to a request from the control system 120, outputs information, which is based on such signals, to the control system 120. And, the control portion 421 also outputs control signals to the paper feed portion 422 and paper storage device control portion 423.

Here, description has been given of the control system 420 of the paper feed apparatus 400. However, the control systems of the remaining paper feed apparatuses are also the same in structure and in function with the control system 420.

In FIG. 2, there is also shown a host computer 20. The host computer 20 is connected to a communication network 21 (for example, a LAN or the like within a corporation or a factory) provided in an environment where the image forming system 1 is disposed. The host computer 20 transmits data about the formation of an image to the image forming system 1 through the communication network 21.

### (Basic Operation)

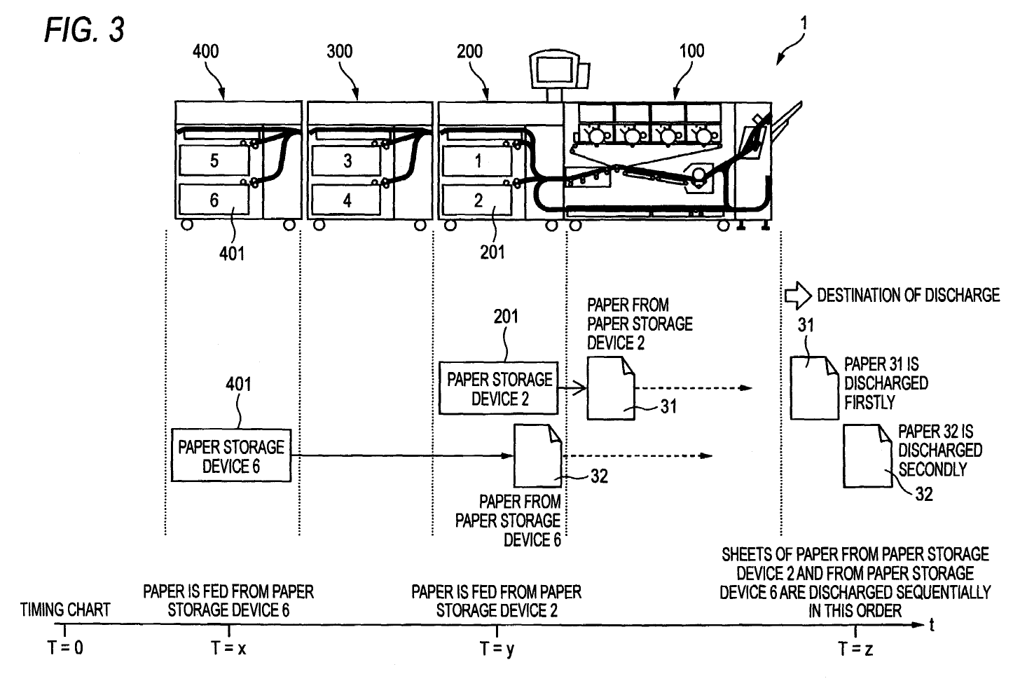

Firstly, description will be given below of the basic operation of the present embodiment. FIG. 3 is a conceptual view of an example of the basic operation. In FIG. 3, in order to facilitate the understanding of the description, there are given serial numerals at the positions of six paper storage devices included in the paper feed apparatuses 200 to 400. Here, reference numerals for designating the respective paper storage devices are the same as shown in FIG. 1.

In FIG. 3, there is shown an example of the timing control that can be carried out when, in the structure of the control system shown in FIG. 2, the control system 120 controls the control systems 220 and 420. That is, in FIG. 3, there is shown an example in which, using paper stored in the paper storage device 2 (201) of the paper feed apparatus 200 and paper stored in the paper storage device 6 (401) of the paper feed apparatus 400, there is produced a printing which is composed of these two kinds of paper. Also, in FIG. 3, there is shown an example in which paper 31 is discharged from the paper storage device 2 (201), paper 32 is discharged from the paper storage device 6 (401), images are formed (printed) in the order of paper 31→paper 32, and the sheets of paper with such images formed thereon are discharged from the image forming system 1 in the order of paper 31→paper 32. Here, these sheets of paper are discharged from the image forming system 1 onto the paper discharge surface 114.

In FIG. 3, there is shown an example in which the interval between the image forming timings of the paper 31 and 32 is controlled not to be wide (that is, in order for the interval between printings not to be large). In other words, a feed passage from the paper storage device 6 (401) to the image forming apparatus 100 is longer than a feed passage from the paper storage device 2 (201) to the image forming apparatus 100. Specifically, the distance between the paper storage device 6 (401) and image forming apparatus 100 is longer than the distance between the paper storage device 2 (201) and image forming apparatus 100. In this example, in order to narrow the interval of the image forming timing caused by the difference between these lengths, the paper 32 is discharged from the paper storage device 6 (401) before the paper 31 is discharged from the paper storage device 2 (201). In other words, in order that, at a stage just before the paper 31 is discharged from the paper storage device 2 (201), the paper 32 has arrived at the neighborhood of the paper storage device 2 (201), the discharge timing of the paper 32 from the paper storage device 6 (401) is set to be earlier than the discharge timing of the paper 31.

When the discharge timing of the paper 32 from the paper storage device 6 (401) has been made to precede the discharge timing of the paper 31, it is possible to narrow the interval between the timing for forming an image on the paper 31 and the timing for forming an image on the paper 32. That is, when compared with a case where the paper 32 is discharged from the paper storage device 6 (401) after the paper 31 is discharged from the paper storage device 2 (201), it is possible to quicken the operation speed when images are formed successively on the paper 31 and 32.

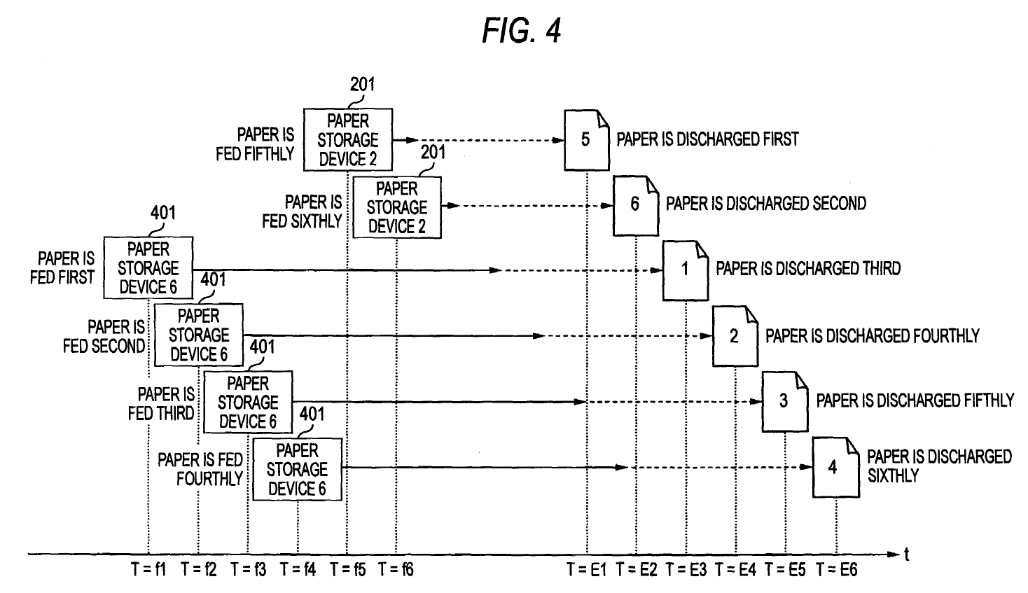

Now, description will be given below of an example of an image forming processing using the principle shown in FIG. 3. FIG. 4 shows an applied example of the operation mode shown in FIG. 3. Specifically, in FIG. 4, there is illustrated an example in which images are formed on six sheets of paper and there is produced a printing composed of these six sheets of paper with the images formed thereon. In this case, there is firstly discharged (there is firstly fed) the paper that is discharged thirdly from the image forming system 1. After then, the sheets of paper to be fed fourthly to sixthly from the image forming system 1 are discharged sequentially from the paper storage device 6 (401). And, after completion of the discharge of the paper from the paper storage device 6 (401), the sheets of paper to be fed firstly and secondly from the image forming system 1 are discharged sequentially from the paper storage device 2 (201).

According to this method, even when the feed length up to the image forming apparatus 100 varies, the timings for forming images on the respective sheets of paper are not spread but the interval between the image forming images can be narrowed. This can prevent the delayed execution of processing for forming images on the six sheets of paper.

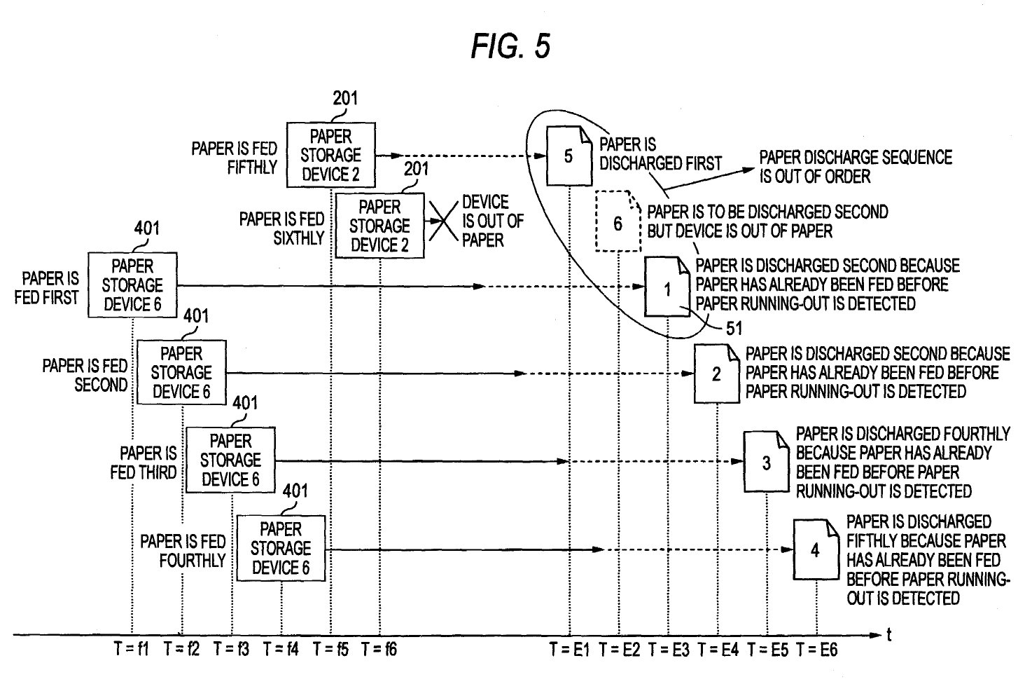

FIG. 5 is a conceptual view of an example of the operation shown in FIG. 4. FIG. 5 shows a case in which, in the operation control shown in FIG. 4, there is not present any paper to be discharged secondly from the system, that is, at a stage where the first sheet of paper is discharged, the paper storage device 2 (201) runs out of paper.

In this case, at the time when the paper storage device 2 (201) runs out of paper and thus the discharge (feed) of paper is impossible, the paper 51 to be fed thirdly from the system has already been discharged from the paper storage device 6 (401) and has been fed up to the vicinity of the paper storage device 2 (201). Therefore, even if, at the time when the above-mentioned running-out of paper is found, the operation to discharge the paper from the paper storage device 6 (401) is stopped, it is impossible to stop the feed of the paper 51 into the image forming apparatus 100. As a result of this, in a state where the paper to be discharged secondly from the system is missing, there is output from the system a printing which is composed of five sheets of paper. That is, there occurs an inconvenience that there is output a printing the order of which is different from the planned order.

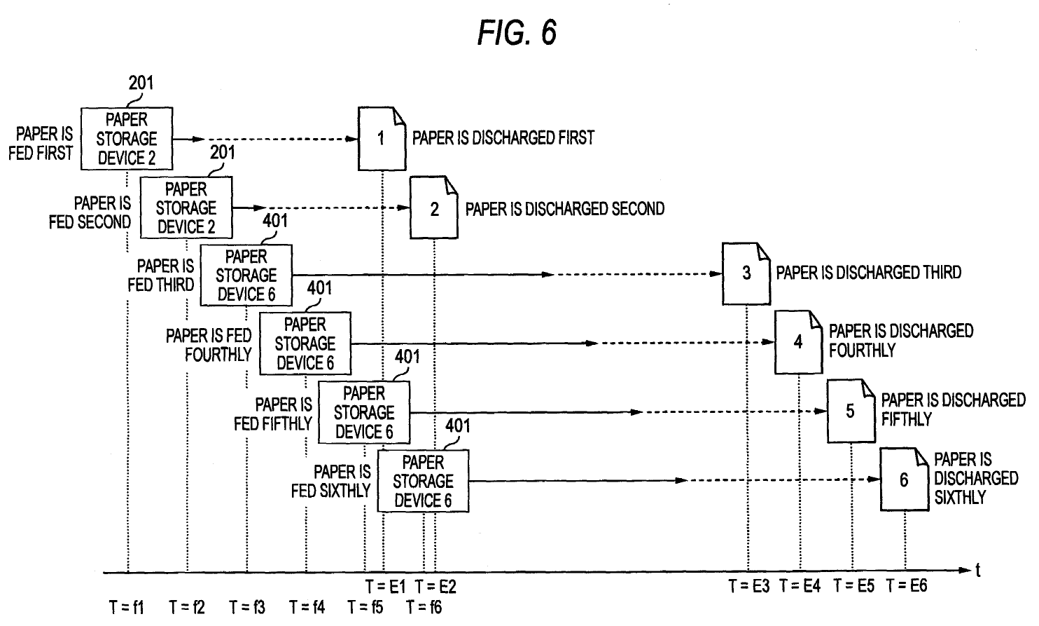

Next, description will be given below of a technology which can cope with this inconvenience. Firstly, as an assumption, description will be given below of a case in which there is not employed a method shown in FIG. 4, that is, a method for previously discharging paper from a paper storage device requiring a long feed passage but there is employed a method for discharging sheets of paper from a paper storage device according to the order in which they are output from the image forming system 1. FIG. 6 is a conceptual view of this operation. Specifically, in FIG. 6, there is shown an example in which sheets of paper are discharged from the paper storage device 2 (202) and paper storage device 6 (401) according to the order in which they are output from the system. Here, the combination of sheets of paper and the discharge order of the sheets of paper from the image forming system 1 (the discharge order of the sheets of paper onto the paper discharge surface 114) are the same as in FIG. 4.

In this case, the discharge order (feed order) of the paper from the paper storage device is the same as the discharge order of the paper from the image forming system 1. Therefore, after the second feeding operation from the paper storage device 2 (201) is executed, the third feeding operation from the paper storage device 6 (401) is carried out. In this case, since the feed passage in the front stage of the image forming apparatus for the paper to be discharged thirdly from the system is long, between the image forming timing of the paper to be discharged secondly from the system and the image forming timing of the paper to be discharged thirdly from the system, there is generated an interval which is greater than the intervals between other image forming timings.

According to the control shown in FIG. 6, after detection of such paper running-out in the paper storage device 2 (201) as shown in FIG. 5, the operation to discharge (feed) the paper of the paper storage device 6 (401) can be stopped, thereby being able to prevent the occurrence of the inconvenience shown in FIG. 5. The reason for this is that the paper discharge order from the system is the same as the paper discharge order (feed order) from the two paper storage devices.

### (Operation of Present Embodiment)

According to the present embodiment, in a state where, of paper storage devices for use in an image forming processing, a paper storage device (in the example shown in FIGS. 4 to 6, the paper storage device 201) having the shortest distance (paper feed distance) from an image forming apparatus does not run out of paper, the control of supply of the paper to the image forming apparatus shown in FIG. 4 is carried out (the control of a mode 1). And, at the time when the present paper storage device almost runs out of paper, the mode 1 control is switched over to the control of supply of the paper to the image forming apparatus shown in FIG. 6 (control of a mode 2). Owing to this, while carrying out the control to narrow the paper discharge interval from the system (that is, while narrowing the paper discharge interval), the occurrence of the inconvenience shown in FIG. 5 can be prevented.

### (Control of Mode 1)

The mode 1 is a mode in which, while the difference between the paper feed passages from the paper storage devices to the image forming apparatus is taken into consideration, the discharge of the paper from the paper storage device having a longer feed passage is carried out prior to the discharge of the paper from the paper storage device having a shorter feed passage. An example of the control of the mode 1 is shown in FIG. 4. According to the example shown in FIG. 4, in order that the difference between the feed distances has no influence on the difference between the image forming timings, before the sheets of paper respectively to be fed first and second from the system (that is, the sheets of paper on which images are formed first and second) are discharged (fed) from the paper storage device 2 (201), the sheets of paper to be fed thirdly to sixthly from the system are discharged (fed) sequentially in this order from the paper storage device 6 (401). This can remove the influence of the difference between the feed passages on the timings for forming images on the respective sheets of paper (in other words, on the paper feed intervals from the system).

### (Control of Mode 2)

The mode 2 is a mode which controls the discharge (feed) of sheets of paper from the paper storage devices toward the image forming apparatus according to an order in which images are formed in the image forming apparatus (according to an order in which the sheets of paper passes through the image forming apparatus). An example of the control of the mode 2 is shown in FIG. 6. According to the example shown in FIG. 6, the discharge order of paper from the paper storage devices toward the image forming apparatus is the same as the feed order of paper from the system (the image forming order). In this case, in the image forming timings on the respective sheets of paper (in other words, in the paper feed intervals from the system), there appears the difference between the feed passages (see FIG. 6).

### (Details of Operation Control)

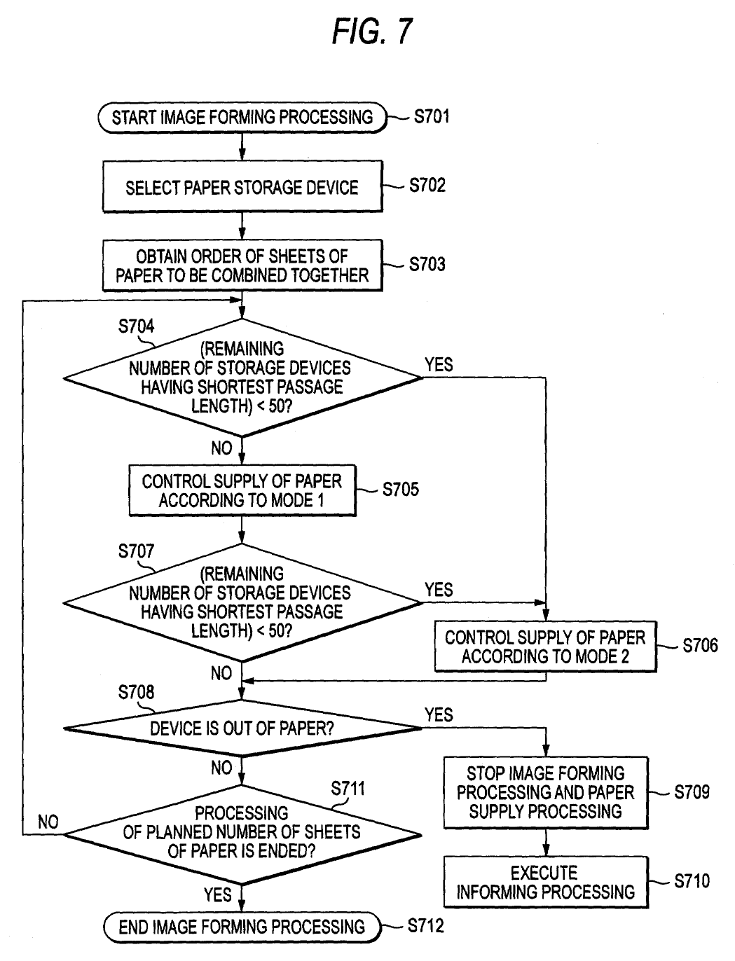

Now, description will be given in detail of the control with reference to an example. FIG. 7 is a flow chart of an example of the operation. An operation program to decide the procedure of the processing shown in FIG. 7 is stored in the RAM of the system control portion 121 shown in FIG. 2. This operation program is read by the system control portion 121, whereby the processing is carried out. In this example, description will be given of a case in which images are formed onto the six sheets of paper respectively shown in FIGS. 4 to 6. Also, in this example, it is assumed that sheets of paper respectively to be stored in the paper storage device 2 (201) and paper storage device 6 (401) are different in kind from each other.

In this example, description will be given below of a case in which data on the image forming processing are sent from the host computer 20 shown in FIG. 2 to the communication network 21 to thereby carry out the image forming processing. The data on the image forming processing to be sent from the host computer 20 include a signal for specifying the formation of images, various setting conditions attendant on the image formation (for example, information on the kind of paper and the like), and data on images. When the data on the image forming processing is sent to the image forming apparatus 100, the image forming processing in the image forming system 1 is started (Step S701). Here, description will be given of an example of a processing to be executed on a copy of a printing. When there are present multiple copies of the same printing (for example, a printing including n pages), the processing shown in FIG. 7 will be carried repeatedly such a number of times as corresponds to the number of the copies of the printing.

When the image forming processing is started (Step S701), the above-mentioned various setting conditions are referred to, thereby selecting a paper storage device to be used (Step S702). In this example, there are selected the paper storage device shown in FIG. 1 and the paper storage device shown in FIG. 2. Information about the selection results is stored into the RAM of the system control portion 121.

Also, while referring to the above various setting conditions, there is obtained information about the combination order of sheets of paper which is necessary for the image formation (Step S703). In this example, in Step S703, as shown in FIGS. 4 and 6, firstly, images are formed sequentially on two sheets of paper output from the paper storage device 2 (201) and, secondly, images are formed sequentially on four sheets of paper output from the paper storage device 6 (401), thereby obtaining information about the paper combination in a case where these six sheets of paper are output from the image forming system 1. The information obtained in Step S703 is stored into the RAM of the system control portion 121 shown in FIG. 2.

After execution of Step S703, it is checked whether the remaining number of sheets of paper stored in the paper storage device selected in Step S702 and having the shortest feed path length to the image forming device is less than 50 or not (Step S704). In this example, this processing is executed on the paper storage device 201 shown in FIG. 1. If the number of sheets of paper stored in the paper storage device 2 (201) is not less than 50, then the processing goes to Step S705; and, if less than 50, then the processing goes to Step S706.

In Step S705, the feed of the paper in the mode 1 is controlled and the image forming processing is carried out. In this case, as shown in FIG. 4, the paper feed control is carried out in the following manner: that is, the feed timing (discharge timing) of the sheets of paper fed thirdly and after then from the system from the paper storage device 6 (401) to the image forming apparatus 100 is set earlier than the feed timing (discharge timing) of the sheets of paper fed firstly and secondly from the system to the image forming apparatus 100 from the paper storage device 2 (201).

When the processing of Step S705 is executed on a sheet of paper, the processing goes to Step S707, where it is checked again whether the remaining number of sheets of paper stored in the paper storage device having the shortest feed passage length to the image forming apparatus is less than 50 or not (Step S707). In this example, in Step S707, it is checked whether the number of sheets of paper remaining in the paper storage device 2 (201) is less than 50 or not. Here, if the number of sheets of paper remaining in the paper storage device 2 (201) is less than 50, then the processing goes to Step S706; and, if not, the processing goes to Step S708.

In Step S706, the supply of paper is controlled in the mode 2. In this example, owing to the execution of the mode 2 control, the sheets of paper discharged firstly and secondly from the system are discharged (fed) respectively from the paper storage device 2 (201) and, next, the sheets of paper discharged in the third to sixth time from the system are discharged (fed) respectively from the paper storage device 6 (401).

In Step S708, it is checked whether at least one of the paper storage devices selected (in this case, the paper storage device 2 (201) and paper storage device 6 (401)) runs out of paper or not. Here, if at least one of them runs out of paper, the image forming processing and the processing to supply the paper to the image forming apparatus are caused to stop (Step S709), thereby stopping the operation of the system. And, there is provided on the display 116b a display to the effect that at least one of them runs out of paper (see FIG. 1), thereby carrying out a processing for informing a user (S710).

In Step S708, if it is found that the device is not out of paper, then the processing goes to Step S711. In Step S711, it is checked whether the total of sheets of paper discharged from the paper storage device to the image forming apparatus reaches the number (in this case, 6) specified by the host computer 20 (FIG. 2) or not. Here, if the total reaches the specified number, then the processing goes to Step S712, where the processing is ended. And, if the total does not reach the specified number, the processing in Step S704 and in the following steps are carried out again.

In the procedure of the processing shown in FIG. 7, at a stage where the number of sheets of paper stored in the paper storage device 2 (201) goes below 50, the processing in Step S706 is carried out and, after then, the mode 2 control on the feed of the paper shown in FIG. 2 (the control on the supply of the paper to the image forming apparatus) is carried out. In this case, when the paper stored in the paper storage device 2 (201) runs out, the processing in and after Step S709 are executed at the time when the paper runs out to stop the supply of the next paper to the image forming apparatus 100, thereby being able to avoid the generation of the inconvenience shown in FIG. 5.

On the other hand, in a state where the number of sheets of paper stored in the paper storage device 6 (401) is 50 or more, the mode 1 control on the feed of the paper shown in FIG. 4 (the control on the supply of the paper to the image forming apparatus) is executed. In this case, the interval between the discharge timing from the system of the paper supplied from the paper storage device 2 (201) and the discharge timing from the system of the paper supplied from the paper storage device 6 (401) (that is, the interval between T=E3 and T=4) can be set the same as other interval (for example, the interval between T=1 and T=2), thereby being able to maintain the processing speed of the system at a high level.

As described above, according to the above embodiment, while preventing the generation of the inconvenience as shown in FIG. 5, the paper processing speed can be controlled properly.

### (Modifications)

The number of sheets of paper, which provides the check standard in Step S704, is not limited to 50 but the number can be selected from the range that can prevent the generation of the inconvenience shown in FIG. 5. The number providing the check standard varies according to the processing capability of the image forming apparatus 100, the size of the paper and the like. Therefore, preferably, the number may have been obtained experimentally and the value of the thus obtained number may be employed.

The image forming system 1 has a structure in which the image forming apparatus 100, paper feed apparatus 200 and the like are formed as units and these units are combined together. However, it may also be a system the whole of which is formed as a unified body. The image forming apparatus 100 is not limited to the structure shown in FIG. 1 but may also have another structure. For example, it may also be structured such that, without using a transfer belt, a toner image is transferred from a sensitive roller directly to the recording member. Also, referring to the principle of applicable image formation, the image is not limited to an image which is formed according to an electro-photographic method but it may also be formed according to an ink jet method or an offset print method. Also, the kind of the paper to be stored in the paper storage device 2 (201) may also be the same as that of the paper to be stored in the paper storage device 6 (401).

The program for deciding the procedure of the processing shown in FIG. 7 may also be a program which is supplied from outside through communication means or a recording medium. That is, the program for deciding the procedure of the processing shown in FIG. 7 may be recorded in a proper recording member or in a proper server; and, at the time when the processing is executed, or at a proper timing, the program may be transferred to the image forming system 1.

The present invention can be applied to a technology which is used to form an image.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. An image forming system comprising:
an image forming apparatus that forms an image on a recording member;
a first recording member storage that stores a first recording member therein;
a second recording member storage that stores a second recording member therein, and that has a longer distance from the image forming apparatus than the distance of the first recording medium storage from the image forming apparatus; and
a control unit that, when the image forming apparatus firstly forms an image on the first recording member and secondly forms an image on the second recording member, executes a first control in which the discharge of the second recording member from the second recording member storage is carried out before the discharge of the first recording member from the first recording member storage, and a second control in which the discharge of the second recording member from the second recording member storage is carried out after the discharge of the first recording member from the first recording member storage, the control unit selecting any one of the first and second controls according to the number of the first recording members stored in the first recording member storage.

2. An image forming system comprising:
an image forming apparatus that forms an image on a recording member;
a first recording member storage that stores a first recording member therein;
a second recording member storage that stores a second recording member therein, and that has a longer distance from the image forming apparatus than the distance of the first recording medium storage from the image forming apparatus; and
a control unit that executes a first control in which the discharge of the first recording member from the first recording member storage and the discharge of the second recording member from the second recording member storage are carried out in the same order as the image forming order in the image forming apparatus, and a second control in which the discharge of the first recording member from the first recording member storage and the discharge of the second recording member from the second recording member storage are carried out in a different order from the image forming order in the image forming apparatus, the control unit selecting any one of the first and second controls according to the number of the first recording members stored in the first recording member storage.

3. The image forming system as claimed in claim 1,
wherein
the first control, when the number of the first recording members stored in the first recording member storage is equal to or more than a predetermined number, is selected, and
the second control, when the number of the first recording members stored in the first recording member storage is less than a predetermined number, is selected.

4. An image forming method comprising:
a first discharging step in which, when, after an image is formed on a first recording member stored in a first recording member storage, an image is formed on a second recording member stored in a second recording member storage more distant from the image forming apparatus than the first recording member storage, prior to the discharge of the first recording member from the first recording member storage, the second recording member is discharged from the second recording member storage; and
a switching step in which, while the first discharging step is being executed, according to the number of the first recording members stored in the first recording member storage, the first discharging step is switched over to a second discharging step in which, after the discharge of the first recording member from the first recording member storage, the second recording member is discharged from the second recording member storage.

5. A computer readable medium storing a program causing a computer to execute a process for forming an image on a recording member, the process comprising:
a first discharging step in which, when, after an image is formed on a first recording member stored in a first recording member storage, an image is formed on a second recording member stored in a second recording member storage more distant from the image forming apparatus than the first recording member storage, prior to the discharge of the first recording member from the first recording member storage, the second recording member is discharged from the second recording member storage; and
a switching step in which, while the first discharging step is being executed, according to the number of the first recording members stored in the first recording member storage, the first discharging step is switched over to a second discharging step in which, after the discharge of the first recording member from the first recording member storage, the second recording member is discharged from the second recording member storage.
